(19) United States
(12) Patent Application Publication
(10) Pub. No.: US 2014/0087337 A1
(43) Pub. Date: Mar. 27, 2014

(54) Persian alphabet teaching and learning game and method thereof

(71) Applicant: Hossein Mirahmadi, Kerman (IR)

(72) Inventor: Hossein Mirahmadi, Kerman (IR)

(21) Appl. No.: 13/624,929

(22) Filed: Sep. 22, 2012

(51) Int. Cl. G09B 19/22

(52) U.S. Cl. 434/128

(57) ABSTRACT

A teaching and learning chess-based game designed to help teach and learn the letters, and sequence of alphabet, as well as dictation of words written in the Persian (Farsi) alphabet, Persian alphabet including 32 characters and being

| no | Letter | name |
|---|---|---|
| 1 | [symbol] | A,e |
| 2 | [symbol] | B,e |
| 3 | [symbol] | P,e |
| 4 | [symbol] | T,e |
| 5 | [symbol] | S,e |
| 6 | [symbol] | Jim |
| 7 | [symbol] | Che |
| 8 | [symbol] | He |
| 9 | [symbol] | Khe |
| 10 | [symbol] | Dal |
| 11 | [symbol] | Zal |
| 12 | [symbol] | R,e |
| 13 | [symbol] | Z,e |
| 14 | [symbol] | Zh,e |
| 15 | [symbol] | Sin |
| 16 | [symbol] | Shin |
| 17 | [symbol] | Sad |
| 18 | [symbol] | Zad |
| 19 | [symbol] | Ta |
| 20 | [symbol] | Za |
| 21 | [symbol] | Aein |
| 22 | [symbol] | Ghaein |
| 23 | [symbol] | Fe |
| 24 | [symbol] | Ghaf |
| 25 | [symbol] | Kaf |
| 26 | [symbol] | Gaf |
| 27 | [symbol] | Lam |
| 28 | [symbol] | Mim |
| 29 | [symbol] | Non |
| 30 | [symbol] | Vav |
| 31 | [symbol] | He |
| 32 | [symbol] | Y,e |

and being different from the western alphabets in that they are written from right to left. According to the embodiments of the present invention the letters of Persian (Farsi) alphabet are either used as, or printed on, chess pieces, are set on a chessboard and are used following the rules of the chess game. The game shall continue one of the players can make a full Persian (Farsi) word by capturing its last letter or they can complete the last of the number of words the two players have initially agreed upon. This way not only do the player(s) learn the shape and sequence of the 32 Persian (Farsi) letters of alphabet, they can also learn the dictation of some words through the game.

### BACKGROUND

1. Technical Field

The present invention relates to the methods used. for teaching and learning alphabet and dictation. The method more specifically relates to the games used for the teaching and learning of alphabet. The invention more specifically relates to the application of a chess-based game for the teaching and learning of Persian (Farsi) alphabet and dictation.

2. Description of the Related Art

Teaching Persian (Farsi) letters has traditionally be performed by using lists of the letters for memorization or through using cards carrying pictures of the letters together with some sample words for the learner to keep in mind. Such methods are rather boring for the learner and usually do not allow a good participation on the part of the teacher or other learners which can boost the learning process.

Other known methods include using rhythmic poems to make the process of learning easier. These methods although less boring, at least at the first stages, are not very interactive for the learner and do not allow enough participation from the others.

To the best of our knowledge there have not been any Persian (Farsi) alphabet and dictation teaching games on record, which can through games and indirectly not only teach and review, but also encourage the learners to actively interact with the other learners or the teacher in the process of education of young children.

### SUMMARY OF THE INVENTION

It is an object of present invention to provide an interesting and amusing method for the introduction and learning of Persian alphabet as well as helping the users learn the dictation of words that are formed during playing the game.

It is another object of the present invention to help the learners of the Persian (Farsi) alphabet learn the sequence of the letters of the alphabet.

It is another object of the present invention to provide a game, having the same playing rules as the classic chess game and using the 32 Persian (Farsi) letters of alphabet as chess pieces, making it possible for the teacher and leaner or two learners take part in the game and process of learning.

It is another object of the present invention to devise the rules of the game so that the participants can also learn the dictation of Persian words formed during the game.

In accordance with the teachings of the patent, a new chess-based game is introduced in which the letters of the Persian (Farsi) alphabet being

TABLE 1
shape and sequence of the 32 Persian (Farsi) letters of alphabet.

| no | Letter | name |
|---|---|---|
| 1 | [symbol] | A,e |
| 2 | [symbol] | B,e |
| 3 | [symbol] | P,e |
| 4 | [symbol] | T,e |
| 5 | [symbol] | S,e |
| 6 | [symbol] | Jim |
| 7 | [symbol] | Che |
| 8 | [symbol] | He |
| 9 | [symbol] | Khe |
| 10 | [symbol] | Dal |
| 11 | [symbol] | Zal |
| 12 | [symbol] | R,e |
| 13 | [symbol] | Z,e |
| 14 | [symbol] | Zh,e |
| 15 | [symbol] | Sin |
| 16 | [symbol] | Shin |
| 17 | [symbol] | Sad |
| 18 | [symbol] | Zad |
| 19 | [symbol] | Ta |
| 20 | [symbol] | Za |
| 21 | [symbol] | Aein |
| 22 | [symbol] | Ghaein |
| 23 | [symbol] | Fe |
| 24 | [symbol] | Ghaf |
| 25 | [symbol] | Kaf |
| 26 | [symbol] | Gaf |
| 27 | [symbol] | Lam |
| 28 | [symbol] | Mim |
| 29 | [symbol] | Non |
| 30 | [symbol] | Vav |
| 31 | [symbol] | He |
| 32 | [symbol] | Y,e |

and being different from the western alphabets in that they are written from right to left are either printed on, or used as, chess pieces according to the table 2:

TABLE 2
Name, proposed order, equivalent chess pieces and capture score
for each of the 32 Persian (Farsi) letters of alphabet.

| Name | Persian letter | Equivalent piece | Capture score |
|---|---|---|---|
| A,e | [symbol] | Rook | 4 |
| B,e | [symbol] | Knight | 2 |
| P,e | [symbol] | Bishop | 3 |
| T,e | [symbol] | Queen | 5 |
| S,e | [symbol] | King | 6 |
| Jim | [symbol] | Bishop | 3 |
| Che | [symbol] | Knight | 2 |
| H | [symbol] | Rook | 4 |
| Khe | [symbol] | Pawn | 1 |
| Dal | [symbol] | Pawn | 1 |
| Zal | [symbol] | Pawn | 1 |
| R,e | [symbol] | Pawn | 1 |
| Z,e | [symbol] | Pawn | 1 |
| Zh,e | [symbol] | Pawn | 1 |
| Sin | [symbol] | Pawn | 1 |
| Shin | [symbol] | Pawn | 1 |
| Sad | [symbol] | Pawn | 1 |
| Zad | [symbol] | Pawn | 1 |
| Ta | [symbol] | Pawn | 1 |
| Za | [symbol] | Pawn | 1 |
| Aein | [symbol] | Pawn | 1 |
| Ghaein | [symbol] | Pawn | 1 |
| Faf | [symbol] | Pawn | 1 |
| Ghaf | [symbol] | Pawn | 1 |
| Kaf | [symbol] | Rook | 4 |
| Gaf | [symbol] | Knight | 2 |
| Lam | [symbol] | Bishop | 3 |
| Mim | [symbol] | Queen | 5 |
| Non | [symbol] | King | 6 |
| Vav | [symbol] | Bishop | 3 |
| H | [symbol] | Knight | 2 |
| Y,e | [symbol] | Rook | 4 |

and are set up on a chess board according to FIG. 1 or any other interchangeable sequences while keeping their equivalent chess piece (according to Table 1) location in mind.

According to an embodiment of the present invention the pieces have the same movement patterns as their equivalent chess piece, as described in Table 3.

TABLE 3
Equivalent chess pieces and their movements

| | | Equivalent |
|---|---|---|
| Letter | Movement | piece |
| (A-H-K-Y)( [symbol] ) | Unlimited Vertical or | Rook |
| | Horizontal | |
| (B-Ch-G-H)( [symbol] | L shaped | Knight |
| [symbol] ) | | |
| (P-J-L-V)( [symbol] ) | Unlimited Horizontal | Bishop |
| (T-M)( [symbol] ) | Unlimited vertical, diagonal | Queen |
| | or horizontal | |
| (N-S)( [symbol] ) | One square vertical, diagonal | King |
| | or horizontal | |
| From ( [symbol] ) to (Sh- | One square vertical, can begin | Pawn |
| [symbol] ) and from (S- [symbol] ) | by moving two squares | |
| to ( [symbol] ) (according | vertically and captures pieces | |
| to table 2) | that are diagonally one | |
| | square in front | |

According to another embodiment of the present invention the set of pieces on the top and bottom of FIG. 1 should have two distinctive colors.

According to a preferred embodiment of the present invention the set of pieces on the, top and bottom of figure should black and white or vice versa.

According to a preferred embodiment of the present invention, and contrary to the rules of chess, any of the two colors shall have the right to start the game.

According to a more specific embodiment of the present invention, the players can have the scores of all captured pieces as mentioned in Table 2, (captured by them and the opponent), once they use their own captured pieces together with the captured pieces of their opponent in a complete and meaningful Persian (Farsi) word. in this case the equivalent score of each captured piece used in the word is added up to calculated the score of the player who captured the last piece used in forming the letter.

According to another specific embodiment of the present invention, once a piece is captured by a player, he can decide to take the same piece or replace it with another equivalent piece, that he thinks can help him to form the Persian word he has in mind. This means he can simply put the captured piece in the place of the desired equivalent piece and remove the equivalent piece.

According to another specific embodiment of the present invention the final score is calculated by adding up the total score of the words made by each opponent.

According to another embodiment of the present invention the players can decide to end the game once one word constituting the agreed number of letters is made, in which case calculating the scores will not be required.

The following example is given to elaborate on the method of playing the game and the subject-matter of the present invention is not limited to the content of this example.

### EXAMPLE

The chess board is set up as shown in FIG. 1, based on table 2. Next, each player makes their first move according to FIG. 2. The game continues by making the next moves according to FIG. 3 and this goes on as a chess game until the one player captures a piece, as in FIG. 4 where for instance the Persian (Farsi) letter “ [symbol] ” is captured and continues as more pieces are captured, like what is shown in FIG. 5 (It is needless to mention that the captured letters may or may not be used in building a Persian (Farsi) word. One should note that if one desires to replace the piece they have captured with another equivalent piece which they think can help the word in mind, this can be done by taking the piece (letter of alphabet) they desires and putting the captured piece in its place. The game finally ends since one player mentions that the three pieces captured in FIG. 6 arte used to build the word(s) and/or “ [symbol] and or [symbol] ” the former meaning well and the latter meaning haying a good sense of humor.

### DESCRIPTION OF THE FIGURES AND DRAWINGS

FIG. 1—The typical arrangement of the Persian (Farsi) alphabet pieces on the board, based on their sequence in the alphabet. The order can be altered keeping their equivalent chess piece (table 1) location in mind

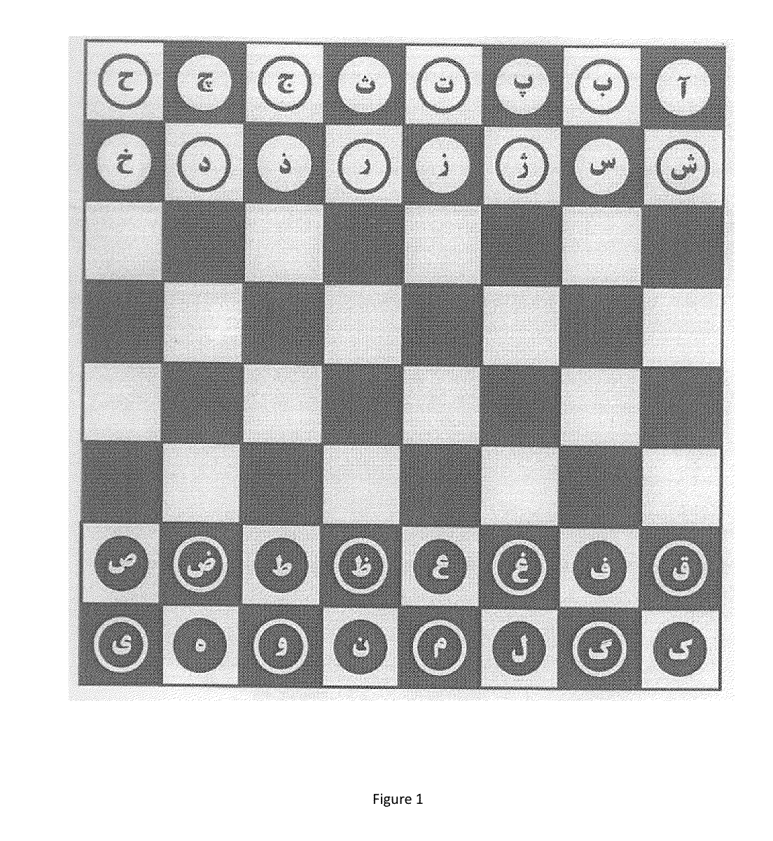

FIG. 2—First and second moves in example 1. The first player moves piece ( [symbol] ) or white pawn straight ahead for one square. Next, the second player moves, piece ( [symbol] ) or the pawn straight ahead for one square.

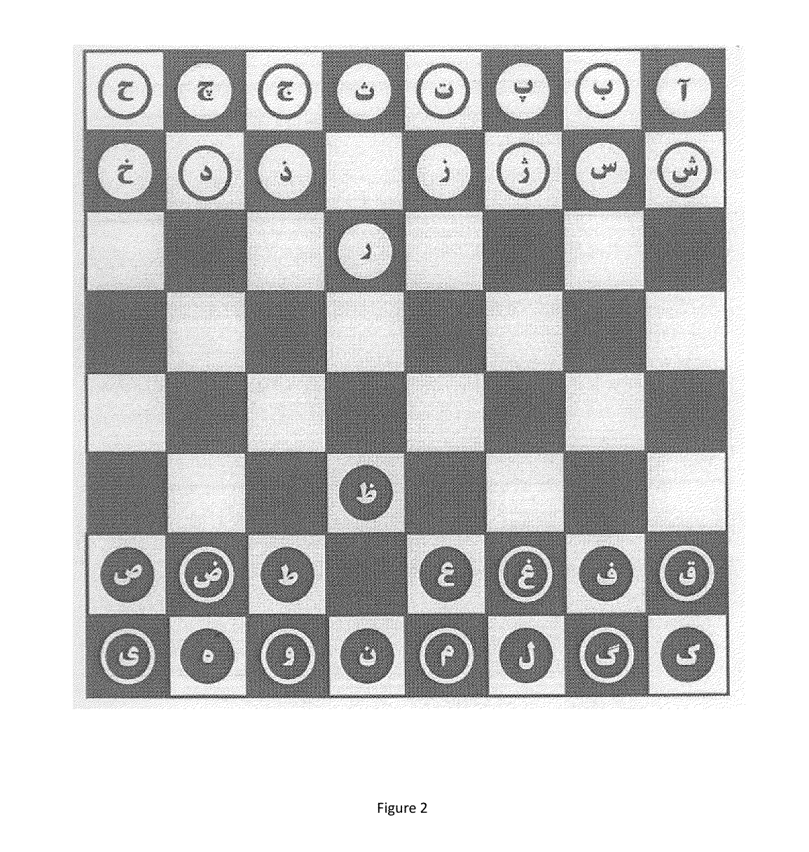

FIG. 3—Third and forth moves. The starting player advances piece( [symbol] )or white knight for one square and then ( [symbol] ) or black bishop moves straight ahead three squares to its right side.

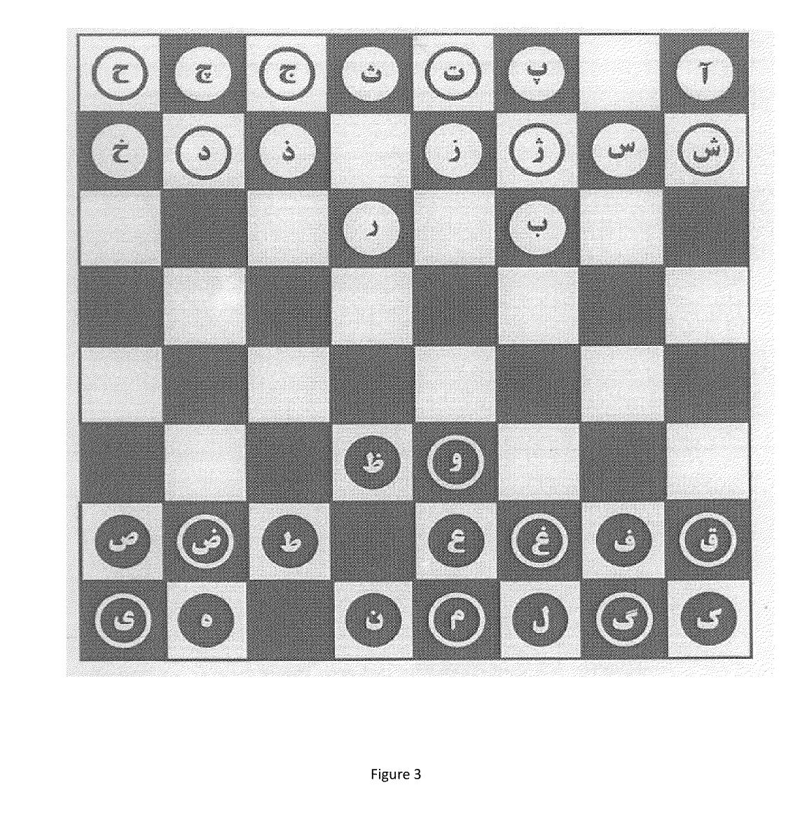

FIG. 4—Fifth move sixth moves. Piece ( [symbol] ) or the very white pawn moves straight ahead one square. Next ( [symbol] ) or black bishop captures the piece ( [symbol] ) and then removes it from the game.

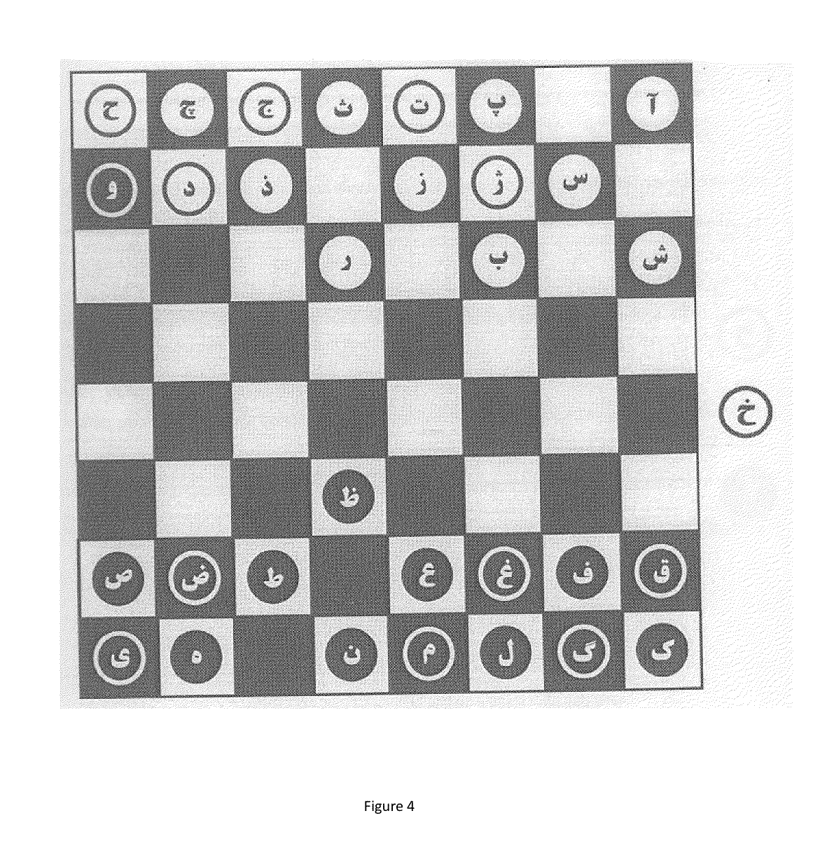

FIG. 5—Seventh and eighths moves. Piece (H) or white rook captures the piece ( [symbol] ) and removes it from the game. Then, piece ( [symbol] ) or black queen moves straight ahead one square to its left side.

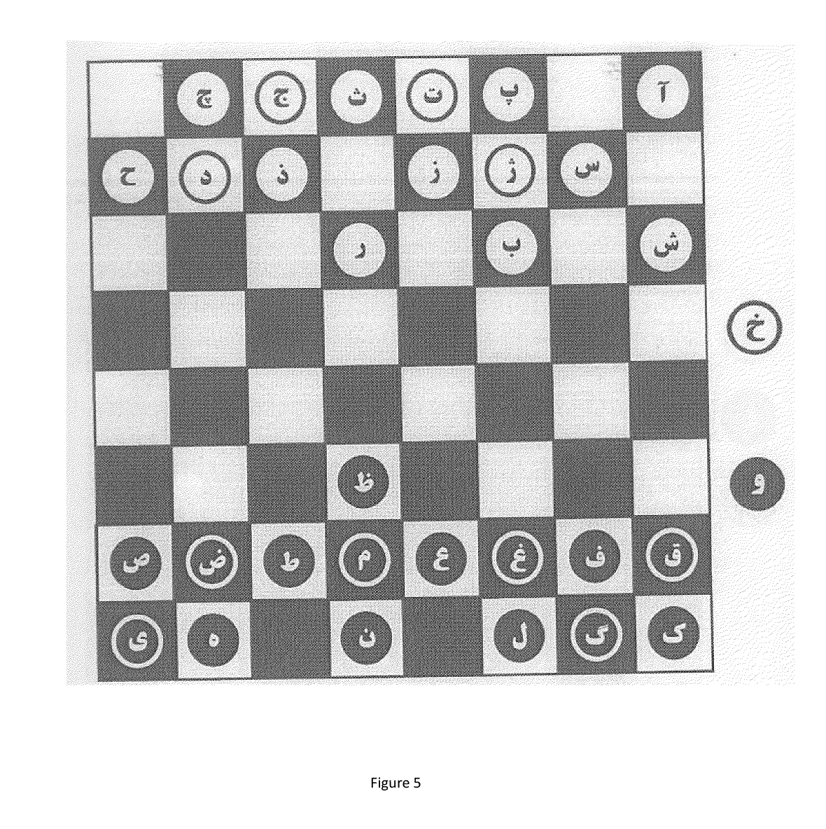

FIG. 6—Ninth and tenth moves. Piece (T) or white queen moves straight ahead three squares to its right side. Then, piece ( [symbol] ) or black queen captures the piece ( [symbol] ) and removes It from the game.

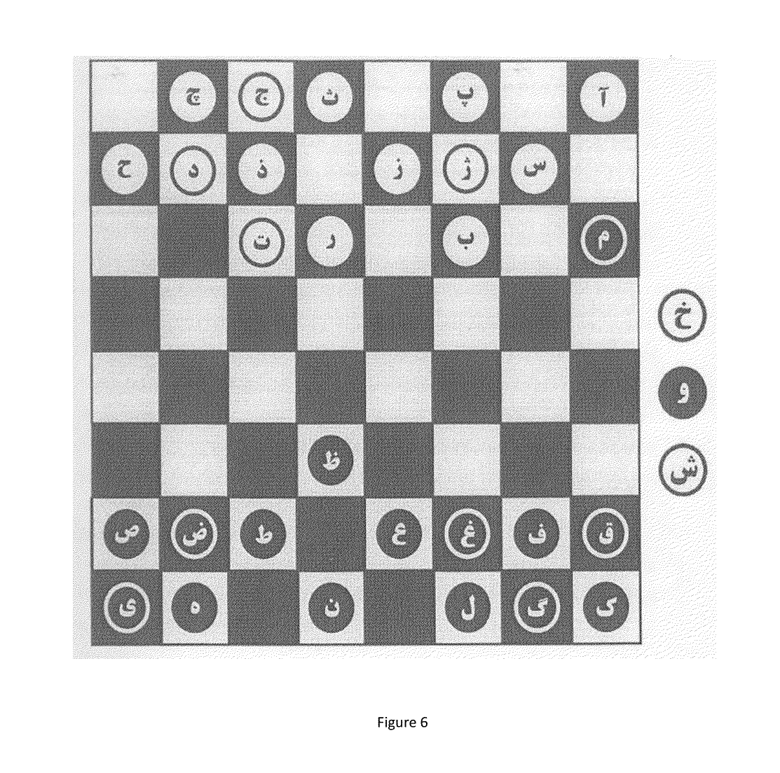

1- A Persian (Farsi) teaching game and playing method thereof, designed to teach and learn the letters and sequence of alphabet as well as dictation of words written iii the Persian (Farsi) alphabet, Persian (Farsi) alphabet being

| no | Letter | name |
|---|---|---|
| 1 | [symbol] | A,e |
| 2 | [symbol] | B,e |
| 3 | [symbol] | P,e |
| 4 | [symbol] | T,e |
| 5 | [symbol] | S,e |
| 6 | [symbol] | Jim |
| 7 | [symbol] | Che |
| 8 | [symbol] | He |
| 9 | [symbol] | Khe |
| 10 | [symbol] | Dal |
| 11 | [symbol] | Zal |
| 12 | [symbol] | R,e |
| 13 | [symbol] | Z,e |
| 14 | [symbol] | Zh,e |
| 15 | [symbol] | Sin |
| 16 | [symbol] | Shin |
| 17 | [symbol] | Sad |
| 18 | [symbol] | Zad |
| 19 | [symbol] | Ta |
| 20 | [symbol] | Za |
| 21 | [symbol] | Aein |
| 22 | [symbol] | Ghaein |
| 23 | [symbol] | Fe |
| 24 | [symbol] | Ghaf |
| 25 | [symbol] | Kaf |
| 26 | [symbol] | Gaf |
| 27 | [symbol] | Lam |
| 28 | [symbol] | Mim |
| 29 | [symbol] | Non |
| 30 | [symbol] | Vav |
| 31 | [symbol] | He |
| 32 | [symbol] | Y,e |

Including two distinctively colored 16 sets of chess pieces and a chess board.

2- The Persian (Farsi) alphabet and dictation teaching game in claim 1 wherein the first 16 set of Persian letters used as the pieces and their corresponding chess pieces and capturing scores are:

| | | | Equivalent Chess | |
|---|---|---|---|---|
| no | Letter | name | Piece | capturing score |
| 1 | [symbol] | A,e | Rook | 4 |
| 2 | [symbol] | B,e | Knight | 2 |
| 3 | [symbol] | P,e | Bishop | 3 |
| 4 | [symbol] | T,e | Queen | 5 |
| 5 | [symbol] | S,e | King | 6 |
| 6 | [symbol] | Jim | Bishop | 3 |
| 7 | [symbol] | Che | Knight | 2 |
| 8 | [symbol] | He | Rook | 4 |
| 9 | [symbol] | Khe | Pawn | 1 |
| 10 | [symbol] | Dal | Pawn | 1 |
| 11 | [symbol] | Zal | Pawn | 1 |
| 12 | [symbol] | R,e | Pawn | 1 |
| 13 | [symbol] | Z,e | Pawn | 1 |
| 14 | [symbol] | Zh,e | Pawn | 1 |
| 15 | [symbol] | Sin | Pawn | 1 |
| 16 | [symbol] | Shin | Pawn | 1 |

3- The Persian (Farsi) alphabet and dictation teaching game in claim 1, wherein the second 16 set of Persian letters used as the pieces and their corresponding chess pieces and capturing scores are:

| | | | Equivalent Chess | |
|---|---|---|---|---|
| no | Letter | name | Piece | capturing score |
| 17 | [symbol] | Sad | Pawn | 1 |
| 18 | [symbol] | Zad | Pawn | 1 |
| 19 | [symbol] | Ta | Pawn | 1 |
| 20 | [symbol] | Za | Pawn | 1 |
| 21 | [symbol] | Aein | Pawn | 1 |
| 22 | [symbol] | Ghaein | Pawn | 1 |
| 23 | [symbol] | Fe | Pawn | 1 |
| 24 | [symbol] | Ghaf | Pawn | 1 |
| 25 | [symbol] | Kaf | Rook | 4 |
| 26 | [symbol] | Gaf | Knight | 2 |
| 27 | [symbol] | Lam | Bishop | 3 |
| 28 | [symbol] | Mim | Queen | 5 |
| 29 | [symbol] | Non | King | 6 |
| 30 | [symbol] | Vav | Bishop | 3 |
| 31 | [symbol] | He | Knight | 2 |
| 32 | [symbol] | Y,e | Rook | 4 |

4- The Persian (Farsi) teaching alphabet and dictation teaching game in claim 1, wherein each of the sixteen letters in each set in set up on the board similar to the order of their equivalent chess pieces.

5- The Persian (Farsi) teaching alphabet and dictation teaching game in claim 1, wherein the Persian (Farsi) letter can either be printed on chess pieces or be used per se as the pieces.

6- The Persian (Farsi) teaching alphabet and dictation teaching game in claim 1, wherein each of the sixteen letters in each set move and capture other pieces similar to their equivalent chess pieces.

7- The Persian (Farsi) teaching alphabet and dictation teaching game in claim 1, wherein the total scores of the captured pieces used to form a complete and meaningful Persian (Farsi) word are allocated to the player who has made the word rather than the one who captured the piece.

8- The Persian (Farsi) teaching alphabet and dictation teaching game in claim 1, wherein each player has the right to replace each captured peace with an equivalent piece by taking the desired piece from the board and putting the captured one in its place.

9- The Persian (Farsi) teaching alphabet and dictation teaching game in claim 1, wherein the game can continue either till both players agree or till the initially agreed number of Persian (Farsi) words with or without the agreed number of letters in each word, are made.

10- The Persian (Farsi) teaching alphabet and dictation teaching game in claim 1 or any other variations thereof, that is adopted for teaching alphabet and dictation of other languages.
